(19) United States
(12) Patent Application Publication
(10) Pub. No.: US 2011/0077166 A1
(43) Pub. Date: Mar. 31, 2011

(54) SURFACE ATTACHMENT

(75) Inventors: Colin Campbell, Edinburgh (GB); Holger Schulze, Edinburgh (GB); Till Bachmann, Edinburgh (GB)

(73) Assignee: ITI SCOTLAND LIMITED, Glasgow, GB (GB)

(21) Appl. No.: 12/922,140

(22) PCT Filed: Mar. 10, 2009
(86) PCT No.: PCT/EP09/52801

§ 371 Date: Nov. 17, 2010

(30) Foreign Application Priority Data
Mar. 11, 2008 (GB) 0804495.0

(51) Int. Cl. C40B 30/04; C40B 50/18; C40B 40/04; C40B 40/06; C40B 40/10; C40B 40/12

(52) U.S. Cl. 506/9; 506/32; 506/15; 506/16; 506/18; 506/19

(57) ABSTRACT

Provided is a method of attaching a substance to a surface, which method comprises contacting a surface comprising amine reactive groups with a substance labelled with a peptide tag such that the substance is covalently attached to the surface via the peptide tag, wherein the peptide tag comprises one or more histidine residues, one of which is a terminal histidine residue having a free N-terminal amino group. Also provided is a method of processing or analysis which comprises a method of attaching a substance to a surface as detailed above and comprises one or more further steps of processing or analysing the substance. The present invention further provides a method of processing or analysis comprising the steps of:
a) attaching a substance to a surface by a method as defined above
b) contacting the surface with a sample comprising an analyte in order that the analyte in the sample binds to the substance attached to the surface; and
c) processing and/or analysing the analyte

The present invention relates to a method of attaching a substance to a surface. Specifically this invention concerns a method of attaching a substance to an amine-reactive surface via a peptide tag comprising one or more histidine residues. The invention further relates to a product or kit for use in such a method, and the use of the peptide tags in the method.

Numerous methods of attaching substances such as proteins, polypeptides, peptides or oligonucleotides to surfaces have previously been described. By selection of the appropriate combination of substance and surface, the binding of the substance to the surface can be optimised.

Methods of modifying substances to enable their attachment to a particular surface, for example by chemically modifying particular functional groups or by incorporating a tag molecule are well known. A review is provided by Chemistry of protein conjugation and cross-linking, Shan S. Wong, CRC Press, 2000.

Also disclosed in the art are surfaces which have been modified with particular functional groups to prevent non-specific interactions and to enable attachment of specific substances. For example, U.S. Pat. No. 6,884,628 describes the use of multifunctional, polyionic copolymer coatings for substrates used in analytical and sensing methods. The coatings are useful in the suppression of non-specific interaction, adsorption or attachment of components present in an analyte solution. Chemical, biochemical or biological groups that are able to recognize, interact with and bind specifically to target molecules in the material containing the analyte to be detected can be coupled to, integrated into or absorbed to the multifunctional copolymers.

The copolymer coatings disclosed in this document include brush copolymers based on a polycationic or polyanionic backbone with side chains that control interaction with the environment, such as poly(ethylene glycol) or poly(ethylene oxide)-based side chains, and analyte specific side chains, for example biotin.

Methods of attaching substances to surfaces have many different applications, for example in microarray technology and in the purification of analytes. The strength and type of interaction between the substance and the surface is tailored to each particular application.

In the field of DNA microarray technology, conventional methods of attaching oligonucleotides to surfaces involve the use of amino-modified or thiol-modified oligonucleotides. Typically, the modified oligonucleotides are attached to epoxy-silane or aldehyde-modified glass substrates. Whilst amino-modified or thiol-modified oligonucleotides are used extensively in combination with epoxy-silane or aldehyde-modified glass substrates in microarray experiments, the efficiency of attachment between the oligonucleotide and the surface is not particularly high, which causes several problems.

Firstly, the number of probe oligonucleotides bound to the surface is not optimal, since when the probe oligonucleotide is contacted with the surface a significant number do not bind, or degrade, or are lost during processing or analysis steps. This means that the sensitivity of the microarray is significantly reduced since there are less binding sites available for the analytes of interest.

Secondly, in microarray technology each different probe oligonucleotide is applied to a different area, or spot, on the surface of the microarray. The fact that each different oligonucleotide is applied to a distinct area enables each oligonucleotide to be analysed independently of the other analytes. If the oligonucleotides do not bind efficiently to the surface, insufficient numbers of oligonucleotides bind to the surface and consequently the distribution of the oligonucleotides on the surface (the morphology of the spot) may be affected.

A further drawback with known DNA microarray techniques is that the hybridization efficiency between the probe and target oligonucleotides is sometimes not optimal. This may be because insufficient numbers of probe oligonucleotides are bound to the surface, providing insufficient binding sites for the target oligonucleotides. Alternatively, this may be because the particular modifications to the oligonucleotide probe molecules known in the art cause the oligonucleotide to be in an orientation which is not the most favourable for hybridization with the target oligonucleotide, or provide spacing between the probe molecules which is not optimal.

A review of microarray technology is provided in Sobek et al, Combinatorial Chemistry & High Throughput Screening, 2006, 9, 365-380.

In recent years, the chemistry of the attachment of proteins and polypeptides to surfaces has also been intensively studied in an attempt to improve methods of purifying proteins and polypeptides. For example, the use of tags such as Glutathione S-transferase (GST) or hexahistidine peptide in the purification of proteins and polypeptides is well documented. Recombinant proteins are expressed with the relevant purification tag at the C or N terminus When a sample comprising the tagged protein is passed over a particular surface, for example the surface of a polymer matrix in a purification column, only the tagged proteins bind to the surface, enabling purification of the tagged proteins.

When histidine tags are used to purify proteins, the surface to which the proteins attach is typically nickel nitrilotriacetic acid (Ni-NTA) (see for example Khan, F., He, M. Y., Taussig, M. J., 2006 Double-hexahistidine tag with high-affinity binding for protein immobilization, purification, and detection on Ni-nitrilotriacetic acid surfaces. Analytical Chemistry 78, 3072-3079). The histidine tag binds to the Ni-NTA via a chelation mechanism, with the tag usually comprising at least six histidine residues to fill the six coordination sites around the nickel ion. The interaction between the histidine tags of the protein and the Ni-NTA matrix is disrupted by the addition of an imidazole solution, as imidazole competes with the histidine residues for coordination around the nickel ion, enabling elution of the tagged protein at the appropriate stage in the purification protocol. The interaction between the histidine tag labeled protein and the Ni-NTA is designed to be relatively weak to allow for the displacement of the protein on addition of imidazole.

Histidine tags have also been used to attach proteins to Ni-NTA surfaces via the chelation mechanism, see for example Lata, S., Piehler, J., 2005, Stable and functional immobilization of histidine-tagged proteins via multivalent chelator headgroups on a molecular poly(ethylene glycol) brush, Analytical Chemistry 77, 1096-1105. However, the low stability of the Ni-histidine complex, whilst providing advantages in protein purification protocols as described above, is problematic in applications where it is necessary for the protein to remain attached to a surface, for example in a microarray.

It is an aim of the present invention to solve one or more of the problems with the prior art described above. Specifically, it is an aim of the present invention to provide an improved method of attaching a substance to a surface via a peptide tag comprising one or more histidine residues. A further objective is to provide methods of analysis comprising the method of attachment, and products or kits for use in such a method.

Accordingly, the present invention provides a method of attaching a substance to a surface, which method comprises contacting a surface comprising amine reactive groups with a substance labelled with a peptide tag such that the substance is covalently attached to the surface via the peptide tag, wherein the peptide tag comprises one or more histidine residues, one of which is a terminal histidine residue having a free N-terminal amino group.

It has been surprisingly found that this combination of peptide tag modification of the substance of interest together with an amine-reactive surface allows for superior attachment of the substance to the surface. The present method enables more efficient reaction between the surface and the substance of interest than methods which use other tags or functional groups known in the art. Consequently in the presently claimed method, more molecules of the substance of interest bind to the surface.

In a preferred embodiment of the present invention the surface comprises epoxy-silane or CodeLink™.

Also provided is a method of processing or analysis which comprises a method of attaching a substance to a surface as detailed above and comprises one or more further steps of processing or analysing the substance.

It has been found that the method of processing or analysis has improved sensitivity over other similar processing or analysis methods known in the art. This is because, as described above, in the presently claimed method more molecules of the substance of interest bind to and stay bound to the surface. Consequently, more molecules are available to be analysed and processed than in the methods according to the prior art, causing a significant increase in the sensitivity of the method.

In a preferred embodiment, the further step comprises detecting the presence or absence of the substance.

In another preferred embodiment, the further step comprises detecting the quantity of the substance.

The present invention further provides a method of processing or analysis comprising the steps of:
a) attaching a substance to a surface by a method as defined above
b) contacting the surface with a sample comprising an analyte in order that the analyte in the sample binds to the substance attached to the surface; and
c) processing and/or analysing the analyte.

This method of processing or analysis also has improved sensitivity relative to the methods known in the art. This is because more of the substance is attached to the surface as discussed above, providing more binding sites for the analyte. Also, the efficiency of binding between the substance attached to the surface and the analyte is higher when the peptide tags according to the present invention are used rather than other modifications. This is possibly because of a favoured orientation of the substance caused by the peptide tag or an optimal spacing between the molecules attached to the surface.

In a preferred embodiment, step c) comprises detecting the presence or absence of the analyte in the sample.

In another preferred embodiment step c) comprises detecting the quantity of the analyte in the sample.

In a yet further preferred embodiment, step c) comprises detecting a signal caused by an analyte in the sample binding to a substance attached to the surface.

The method may be for analysing a plurality of analytes, wherein a plurality of substances are attached to the surface, each substance being specific to a different analyte. Different substances may be attached to different areas of the surface such that different analytes bind to different areas of the surface. This embodiment is advantageous in that it enables different analytes to be processed or analysed independently of each other.

The different areas (or spots) have improved morphology in the present method relative to methods known in the art. This is due to the fact that more molecules of the substance of interest are bound to the surface in the present method than in similar methods known in the art. Further, the peptide tag allows for a favoured orientation of the molecules, as well as optimal spacing between the molecules. The improved spot morphology of the claimed method allows for more sensitive and efficient processing and analysis.

In a preferred embodiment of the invention, the analyte is an oligonucleotide which comprises a nucleotide sequence which is complementary to a nucleotide sequence of one or more of the substances attached to the surface. In this case the binding step involves hybridization of complementary sequences. This method has enhanced hybridization efficiency relative to the methods known in the art. This is thought to be due to the increased number of probe oligonucleotide molecules bound to the surface, as well as improved orientation and spacing of the probe oligonucleotides provided by the peptide tag.

Also provided is a product for analysing one or more analytes in a sample comprising: a surface comprising amine-reactive groups; and a substance covalently bound to the surface via a peptide tag comprising one or more histidine residues, one of which is an N-terminal histidine residue, whereby the substance bound to the surface is capable of binding to an analyte of interest.

The present invention further provides a kit for analysing one or more analytes in a sample comprising: a substrate which has a surface comprising amine-reactive groups; and a liquid comprising a substance capable of binding to an analyte of interest in the sample; each substance labelled with a peptide tag comprising one or more histidine residues, one of which is a terminal histidine residue having a free N-terminal amino group.

The product or kit preferably comprises a surface comprising epoxy-silane or CodeLink™.

The products or kits provide the same advantages as the corresponding methods.

The present invention will now be described further by way of example only with reference to the accompanying drawings, in which:

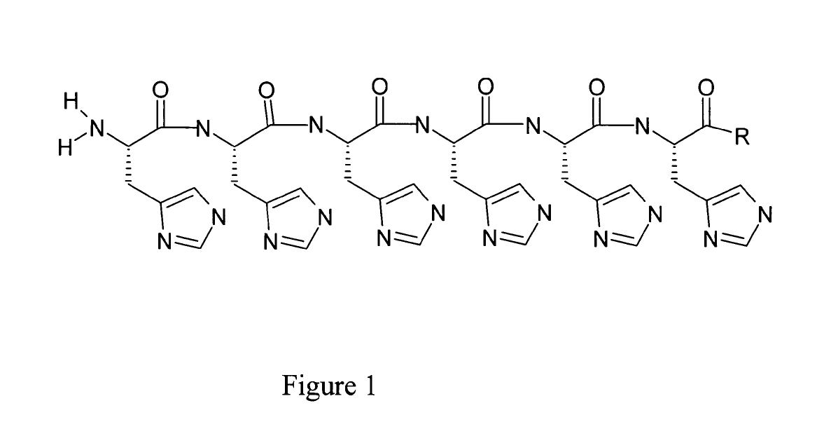

FIG. 1 shows an example of the peptide tag according to the present invention.

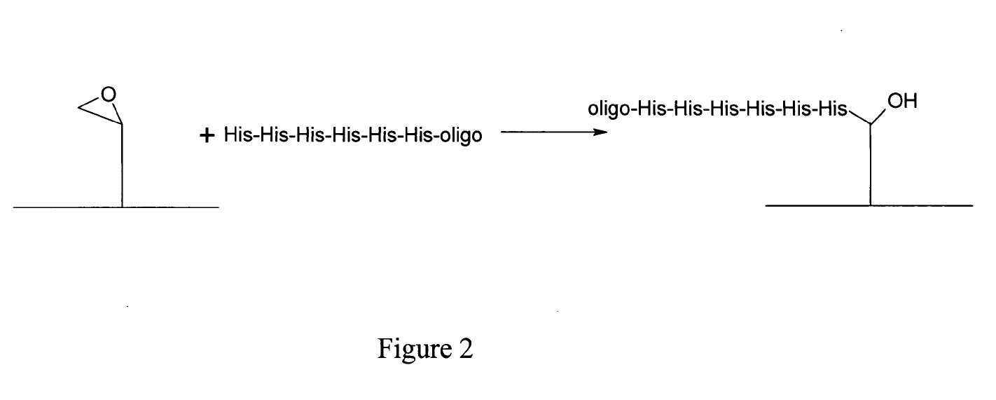

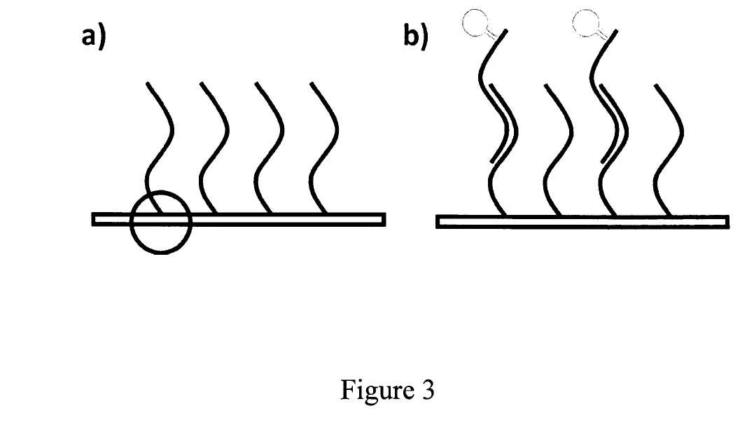

FIG. 2 shows a schematic of the mode of attachment of the substance modified with a peptide tag to the amine-reactive surface.

FIG. 3 shows a schematic of a method of analysis according to the present invention: a) the substance modified with the peptide tag binds to the amine-reactive surface and b) the surface is contacted with a sample comprising an analyte in order that the analyte in the sample binds to the substance attached to the surface.

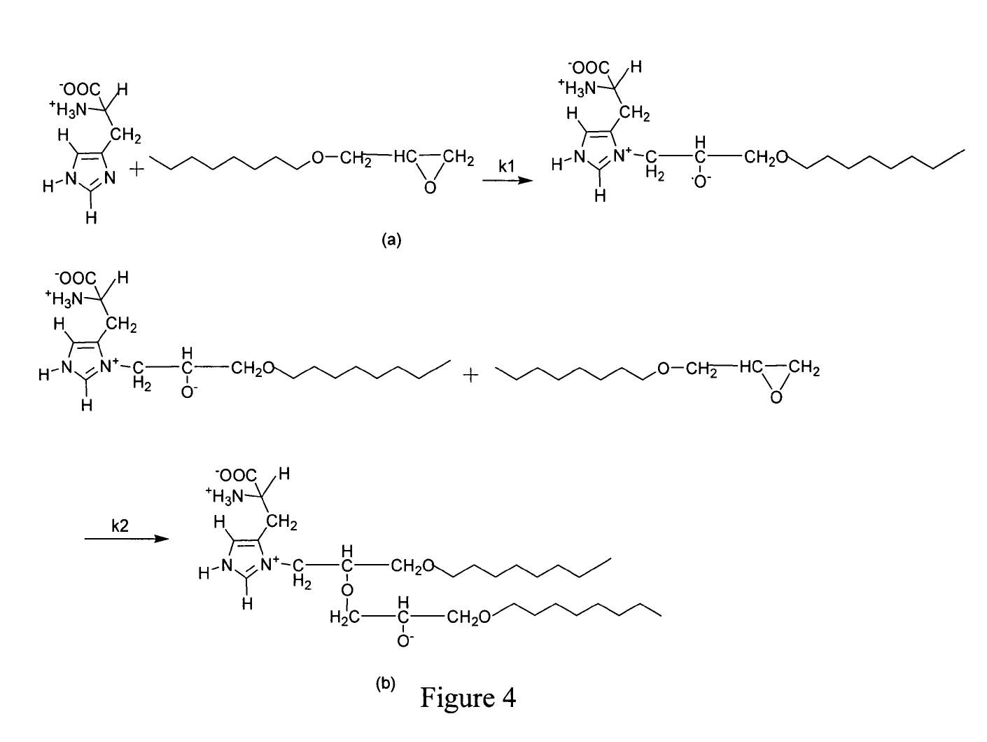

FIG. 4 shows the mechanism of the reaction of the imidazole group of a histidine residue with an epoxy polymer: (a) reaction initialization and (b) molecular chain propagation and cross-linking.

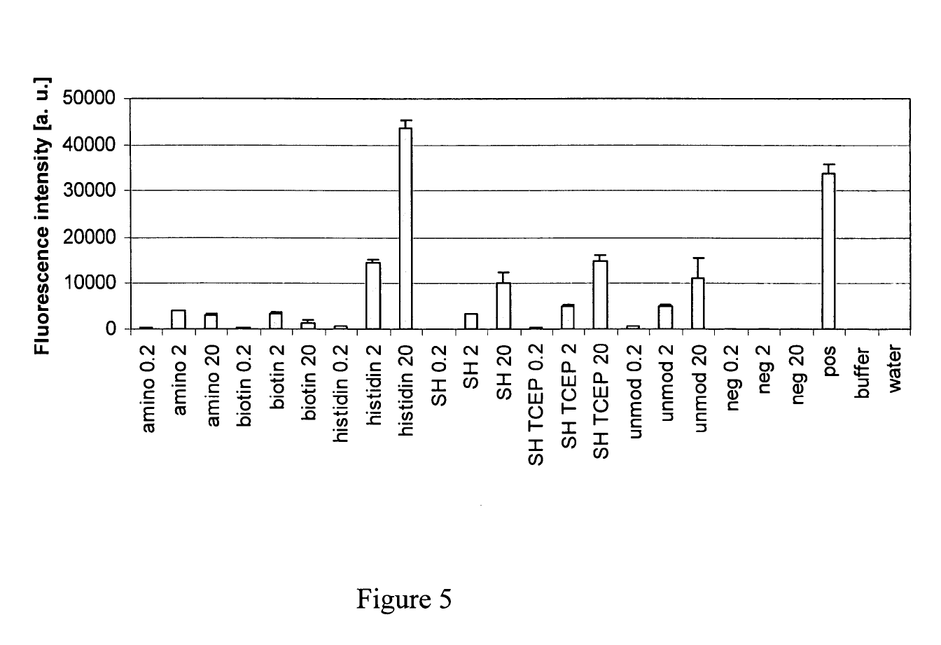

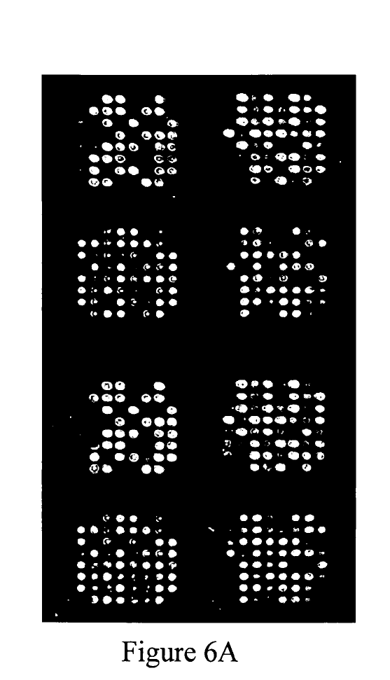

FIG. 5 shows a plot of the mean fluorescence intensities after hybridization with Cy-3-labelled complementary target (100 nM) on an array of differentially functionalized probes, spotted at three concentrations (0.2 μM, 2 μM and 20 μM) on Erie Scientific epoxy silane slides. N=30.

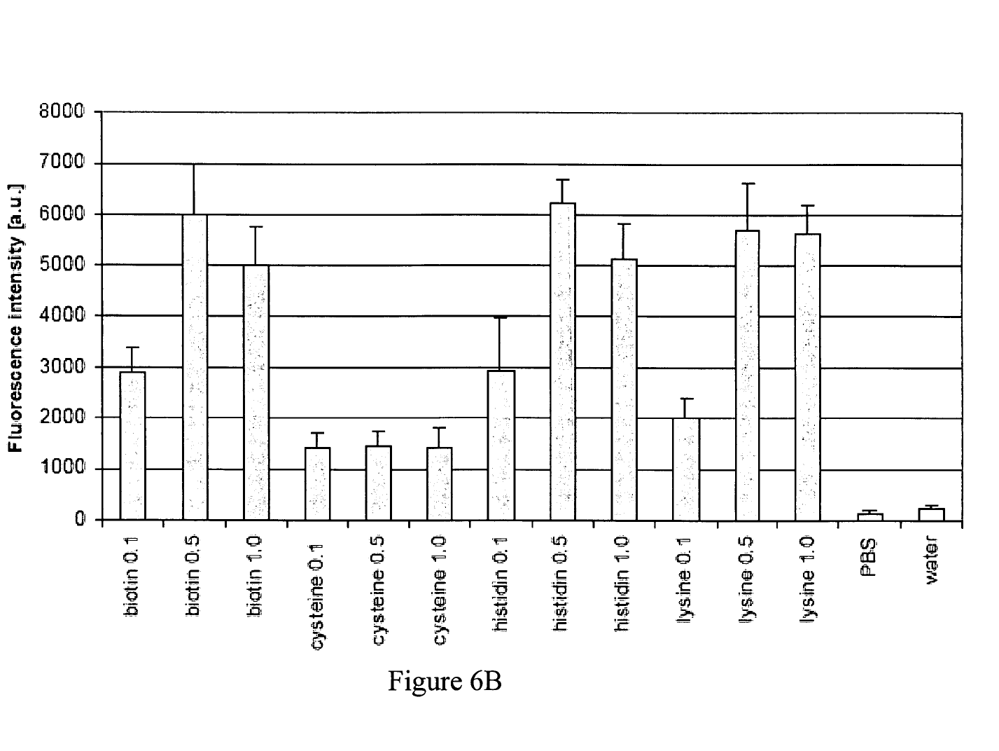

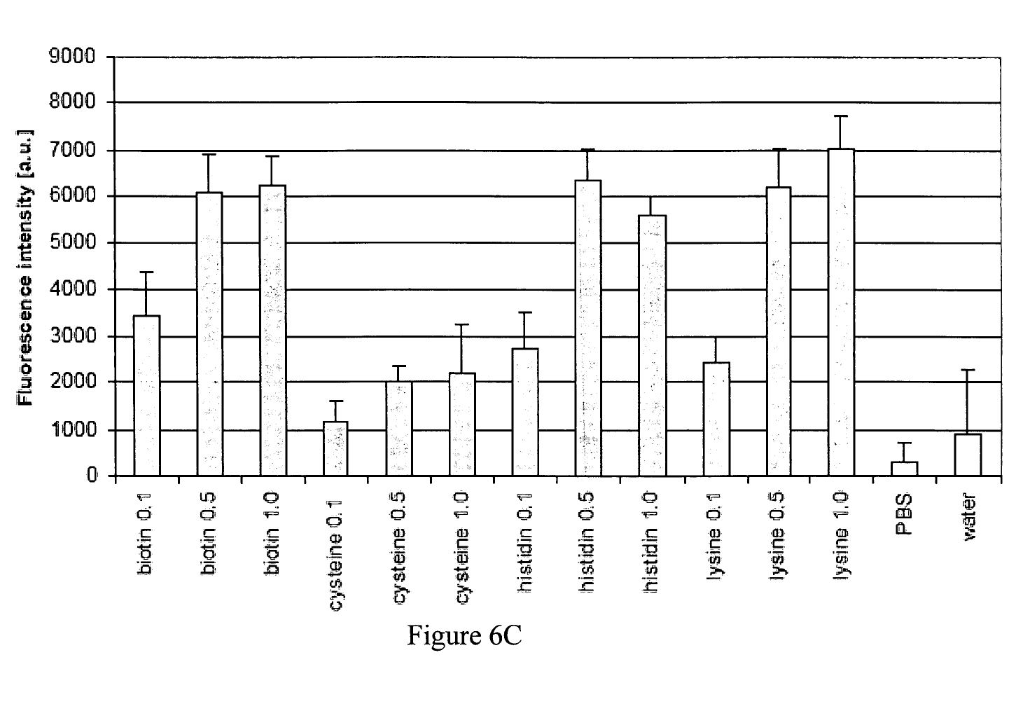

FIG. 6 shows a fluorescence image of a 4D8 scAb antibody array on Erie Scientific® epoxy silane slides stained with Deep Purple™ Total Protein Stain (left) and mean fluorescence intensities (right) of two identical subarrays (top and bottom right) of differentially functionalized 4D8 scAbs, spotted at three concentrations (0.1 mg/mL, 0.5 mg/mL, and 1 mg/mL); n=15.

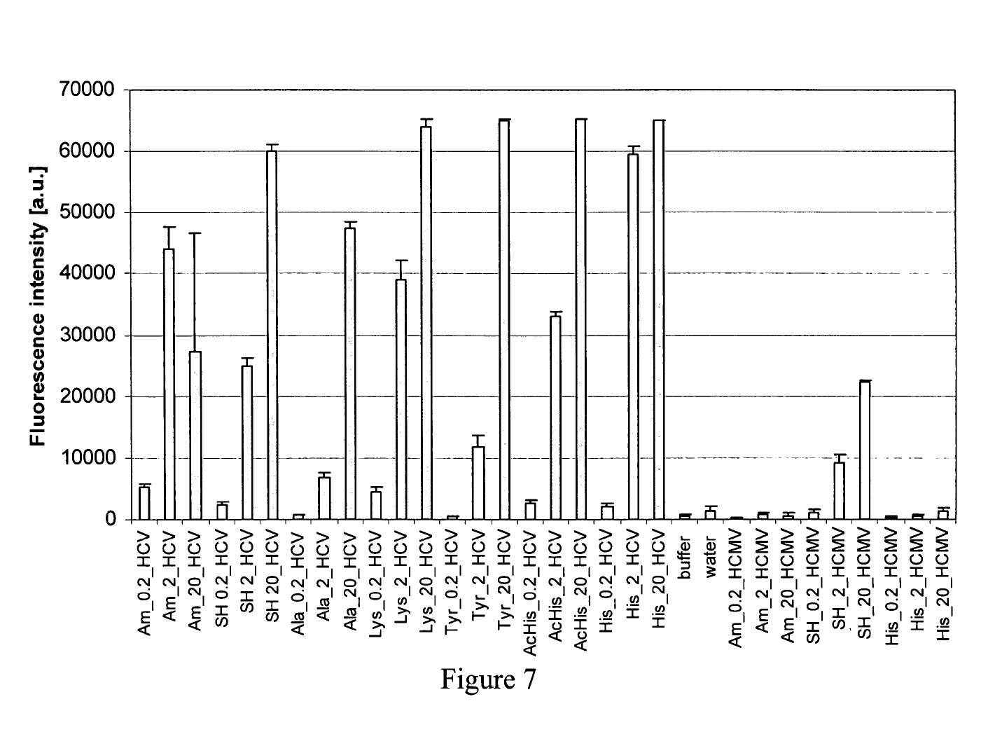

FIG. 7 shows mean fluorescence intensities after hybridization with 100 μM Cy3-labelled complementary target on an array of differentially functionalized probes, spotted at three concentrations (0.2 μM, 2 μM, and 20 μM) on Schott Nexterion epoxy silane slides. n=5. [Am=amino; SH=thiol; Ala=6× alanine; Lys=6× lysine; Tyr=6× tyrosine; AcHis=6× His with acetylated terminal amino group; His=6× His].

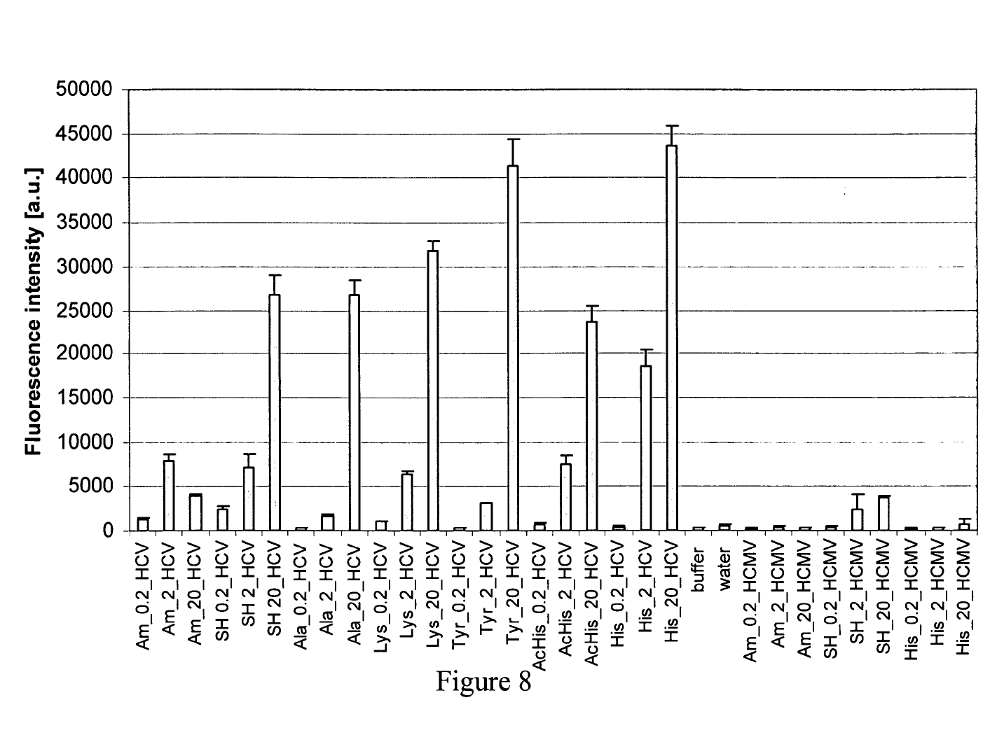

FIG. 8 shows mean fluorescence intensities after hybridization with 10 μM Cy3-labelled complementary target on an array of differentially functionalized probes, spotted at three concentrations (0.2 μM, 2 μM, and 20 μM) on Schott Nexterion epoxy silane slides. n=5. [Am=amino; SH=thiol; Ala=6× alanine; Lys=6× lysine; Tyr=6× tyrosine; AcHis=6×His with acetylated terminal amino group; His=6×His].

The present invention will now be described in detail.

The methods according to the present invention may be used to attach any type of substance to a surface, provided that attachment to the surface is effected via a peptide tag comprising one or more histidine residues attached to, or incorporated into, the substance. However, it is preferred that the substance is selected from a protein, peptide, polypeptide, carbohydrate, nucleic acid, locked nucleic acid, peptide nucleic acid or oligonucleotide. Oligonucleotides used in the present invention may be RNA or DNA.

The peptide tag used in the present invention comprises one or more histidine residues and the terminal histidine residue has a free N-terminal amino group. The sequence of the peptide tag is otherwise not especially limited, and may comprise other amino acid residues in addition to histidine, including modified amino acids.

Preferably, the peptide tag comprises 1 to 20 histidine residues. More preferably, the peptide tag comprises 1 to 12 histidine residues. In a yet further preferred embodiment, the peptide tag comprises 1 to 8 histidine residues. In a still further preferred embodiment, the peptide tag comprises 6 histidine residues.

Preferably the peptide tag also comprises one or more cysteine residues. More preferably, the peptide tag comprises 1 to 5 cysteine residues. More preferably still, the peptide tag comprises 1 to 3 cysteine residues. In a yet further preferred embodiment, the peptide tag comprises 1 or 2 cysteine residues. In a still further preferred embodiment, the peptide tag comprises 1 cysteine residue.

Typically, the peptide tag comprises 1 to 20 histidine residues and 1 to 5 cysteine residues. More preferably, the peptide tag comprises 1 to 12 histidine residues and 1 to 3 cysteine residues. In a yet further preferred embodiment, the peptide tag comprises 1 to 8 histidine residues and 1 or 2 cysteine residues.

In the most preferred embodiment, the peptide tag comprises 6 histidine residues and 1 cysteine residue.

The method of incorporating the peptide tag into the substance of interest is not especially limited, but typically differs depending on the substance of interest. For example, in the case of peptides, polypeptides and proteins, standard recombinant DNA techniques are used to prepare vectors which enable the expression of the peptides, polypeptides or proteins of interest with peptide tags attached.

In the case of oligonucleotides, the peptide tag is preferably attached at the 5′ end.

The surface to which the substance is attached is not especially limited, provided that the surface comprises amine reactive groups. Any surface which reacts with the amine groups of histidine residues may be used. It is preferred that the surface comprises epoxy-silane or CodeLink™. CodeLink™ slides are sold under license from Surmodics Inc. Details of the composition of the CodeLink™ surface can be found in U.S. Pat. Nos. 5,741,551 and 5,512,329. In a preferred embodiment the surface is situated on a substrate. Typically, the substrate comprises glass. Alternatively, any metal, metal oxide, silicon dioxide, silicon nitride, ceramic, semiconductor, polymer or plastic substrate that can be suitably modified may be used. Other substrates commonly used in microarray technology can also be used.

The term “amine-reactive group” means any functional group which reacts with amines Usually, these functional groups are electrophilic functional groups or functional groups which undergo nucleophilic attack. The surface may comprise N-hydroxysuccinimide ester groups. These functional groups are conjugated to polymers which minimise non-specific interactions. Usually the polymers are hydrophilic polymers. The polymer may comprise covalent cross-linking.

The peptide tag forms a covalent bond with the amine-reactive surface. It is understood that the strong interaction between the peptide tag and the amine-reactive groups is caused by activation of the terminal amino group of the terminal histidine residue by adjacent imidazole groups and the reaction of the secondary amine of the histidine side chain (the imidazole amine group) with the surface amine-reactive group. Accordingly, in preferred embodiments of the invention, the substance is attached to the surface through a secondary amine group of the terminal histidine residue. In such embodiments, attachment through the secondary amine groups means attachment of the type depicted in FIG. 4.

FIG. 4 shows the reaction of an imidazole group (such as the imidazole group of a histidine residue) with an epoxy group (such as found in the epoxy silane polymer used in the present invention). The nucleophilic secondary amine of the imidazole residue reacts with the electrophilic epoxy group. This mechanism is also applicable to the CodeLink™ surface. Further details of this mechanism can be found in Shi S. H., Yamashita T., Wong C. P. (1999), development and characterization of imidazole derivative cured bisphenol A epoxy materials for flip-chip underfill applications, Proceedings International Symposium on Advanced Packaging Materials 14-17, 317-324.

Also provided is a method of processing or analysis which comprises a method of attaching a substance to a surface as described above and additionally comprises one or more further steps of processing or analysing the substance.

The term “processing” is not particularly limiting, and includes any further reaction of the substance of interest once it is attached to the surface. For example a peptide, polypeptide, protein or oligonucleotide may undergo an enzymatic or chemical reaction once attached to the surface. The term “processing” includes the purification of the substance once attached to the surface. Processing steps include washing the surface, blocking binding sites for the analyte, incubation, or amplification if the substance is a nucleic acid. The processing step may also involve the substance undergoing binding reactions or further chemical modifications such as cleavage, phosphorylation or methylation.

The term “analysis” is also not especially limiting, and includes detecting the presence or absence of the substance, or the quantity of the substance. The term “analysis” may also refer to the characterisation of the physical, structural or chemical properties of the substance. The analysis may also include measurement of changes in optical, electrochemical or mechanical signals. Typically such analysis involves measurement of fluorescence, luminescence, current, voltage, impedance, capacitance, resonant frequency, surface profile (AFM), Plasmon resonance or dual polarisation interferometry.

The method may also include a step of washing the surface with a liquid. This step preferably occurs after attaching the substance to the surface but before the processing or analysis step. The liquid may comprise a buffer such as phosphate, Tris, Hepes, Mops or Borate. The liquid may also comprise a detergent, for example Tween®.

The liquid may be selected from solutions comprising one or more of Triton® X-100, HCl, KCl or water. The liquid may be a 0.1% Triton® X-100 solution. Alternatively, the liquid may be a 1 mM HCl solution. A solution of 100 mM KCl may also be used.

The method may include a step of washing the surface with a blocking solution. An example of an appropriate blocking solution is a solution ethanolamine in Tris buffer, typically an ethanolamine solution in 10 mM Tris buffer at pH 9.

In a further embodiment, the method of processing or analysis comprises the steps of:
a) attaching a substance to a surface by a method as described above;
b) contacting the surface with a sample comprising an analyte in order that the analyte in the sample binds to the substance attached to the surface; and
c) processing and/or analysing the analyte.

The method can additionally comprise a mixing step. This method may also further comprise a wash step. In a preferred embodiment the wash step occurs after step b) but before step c). The liquid may be a solution comprising one or more of sodium chloride, sodium citrate or sodium dodecyl sulphate (SDS).

The term “analyte” is not particularly limiting, and the methods according to the present invention may be employed to process or analyse any type of molecule provided that it can bind to the substance attached to the surface. However, it is preferred that the analyte is selected from a protein, peptide, polypeptide, carbohydrate, nucleic acid, locked nucleic acid, peptide nucleic acid or oligonucleotide. Oligonucleotides used in the present invention may be RNA or DNA.

The term “sample” refers to any specimen in which an analyte may be present. The sample may comprise a mixture of analytes. For example, the sample may be a blood or stool sample, urine, cerebrospinal fluid, saliva, sputum, a swab or lavage sample, water, food, air, soil, a cell lysate or a solution resulting from a gel digest.

The term “contacting” is not especially limiting. Typically, the sample is applied to the surface using a liquid handler. The liquid handler may be a contact spotter or a contact-free spotter. The sample may also be applied to the surface manually.

In a method according to the invention, the analyte in the sample binds to the substance attached to the surface. The interaction may be any kind of specific interaction. The analyte may bind via non covalent interactions such as hydrogen bonds, Van der Waals or hydrophobic interactions. For example, such a binding event may comprise the binding of an antigen to an antibody.

In a preferred embodiment of the invention, the analyte is an oligonucleotide which comprises a nucleotide sequence which is complementary to a nucleotide sequence of one or more of the substances attached to the surface. In this case the binding step involves hybridization of complementary sequences. In order to effect hybridization, a heating step may be required. This may be followed by one or more steps of washing the surface with liquids of different concentrations or stringencies.

The analysis or processing step of the method according to the present invention may comprise detecting a signal caused by an analyte in the sample binding to a substance attached to the surface.

The method may be for analysing a plurality of analytes, wherein a plurality of substances is attached to the surface, each substance being specific to a different analyte. In a preferred embodiment, different substances are attached to different areas of the surface, such that different analytes bind to different areas of the surface to enable different analytes to be processed or analysed independently of each other. In a particularly preferred embodiment, the surface is the surface of a microarray.

The analysis or processing step may comprise measuring the relative quantities of two or more different analytes in the sample. Preferably, each different analyte produces a signal which can be distinguished from the signals produced by other analytes.

The analytes in the sample or the substances attached to the surface may also further comprise a reporter group. Preferably, each different analyte or substance comprises a different reporter group. Usually, each different reporter group produces a signal which can be distinguished from the signals produced by other reporter groups. The relative intensities of each signal can be used to measure the relative quantities of each different analyte or substance.

In a preferred embodiment, the reporter group is a fluorescent molecule. For example the cyanine dyes Cy3 or Cy5 may be used:

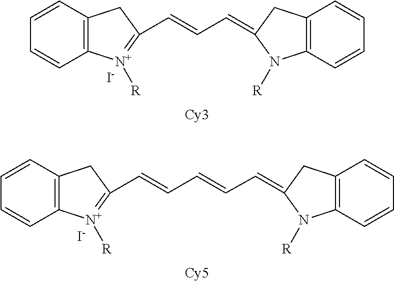

Alternatively, fluorescein or TAMRA may be used. When the reporter group is a fluorescent molecule, fluorescence spectroscopy may be used to detect the molecule of interest. In particular, microarray scanners may be used.

Alternatively, the reporter groups may be enzymes, electrochemically active compounds such as methylene blue or ferrocene, or a dye used in Surface-enhanced Resonance Raman Scattering (SERRS).

In a further embodiment the reporter groups may be nanoparticles. Preferably the nanoparticles are selected from metals, metal nanoshells, metal binary compounds and quantum dots. Examples of preferred metals or other elements are gold, silver, copper, cadmium, selenium, palladium and platinum. Examples of preferred metal binary and other compounds include CdSe, ZnS, CdTe, CdS, PbS, PbSe, HgI, ZnTe, GaAs, HgS, CdAs, CdP, ZnP, AgS, InP, GaP, GaInP, and InGaN.

Metal nanoshells are sphere nanoparticles comprising a core nanoparticle surrounded by a thin metal shell. Examples of metal nanoshells are a core of gold sulphide or silica surrounded by a thin gold shell.

Quantum dots are semiconductor nanocrystals, which are highly light-absorbing, luminescent nanoparticles (West J, Halas N, Annual Review of Biomedical Engineering, 2003, 5: 285-292 “Engineered Nanomaterials for Biophotonics Applications: Improving Sensing, Imaging and Therapeutics”). Examples of quantum dots are CdSe, ZnS, CdTe, CdS, PbS, PbSe, HgI, ZnTe, GaAs, HgS, CdAs, CdP, ZnP, AgS, InP, GaP, GaInP, and InGaN nanocrystals.

Other possible detection methods include optical waveguide detection, dual polarisation interferometry, surface plasmon resonance, UV or visible spectroscopy, Fourier transform infrared spectroscopy (FTIR), Raman spectroscopy, ELISA, mass spectrometry, electrochemical, mechanical, gravimetric, microbalance, piezoelectric or surface acoustic wave (SAW) detection.

Also provided is a product for analysing one or more analytes in a sample, comprising a surface comprising amine-reactive groups; and a substance covalently bound to the surface via a peptide tag comprising one or more histidine residues, one of which is an N-terminal histidine residue, whereby the substance bound to the surface is capable of binding to an analyte of interest. The surface is preferably the surface of a glass substrate, and more preferably the surface of a glass slide. Alternatively, any metal, metal oxide, silicon dioxide, silicon nitride, ceramic, semiconductor, polymer or plastic substrate that can be suitably modified may be used. Other substrates commonly used in microarray technology can also be used.

Further provided is a kit for analysing one or more analytes in a sample comprising: a substrate which has a surface comprising amine-reactive groups; and a liquid comprising a substance capable of binding to an analyte of interest in the sample; each substance labelled with a peptide tag comprising one or more histidine residues, one of which is a terminal histidine residue having a free N-terminal amino group.

The invention will now be described in further detail by way of example only, with reference to the following specific embodiments.

### EXAMPLES

### Example 1

### Preliminary Experiments

### DNA Microarrays

A microarray was prepared using differentially functionalized oligonucleotide probes, spotted at three concentrations (0.2 μM, 2 μM and 20 μM) on Erie Scientific® epoxy silane slides (n=30). The probe modifications tested were the commonly used amino and thiol and biotin groups, as well as the peptide tags according to the present invention. The probes were then contacted with a solution of 100 nM Cy3-labelled complementary target oligonucleotide.

As can be seen in FIG. 5, the best results in hybridization studies with a complementary fluorescently labelled target were obtained with the histidine-tag-modified oligonucleotides of the present invention. Histidine-tag probe molecules exhibited excellent binding towards epoxy silane, CodeLink™, and Ni-NTA-modified slides. The fluorescence signal obtained with histidine-tag-modified probes was approximately 10-times higher than the more commonly used amino-modified probes and about 3-times higher than thiol-modified probes. Histidine-tag modified probes also revealed a much better spot morphology than any other tested probe modification.

### Protein Microarrays

In order to investigate the binding of the differentially functionalized antibody fragments on glass slides, three different concentrations (0.1 mg/mL, 0.5 mg/mL, and 1 mg/mL) of the four anti-microcystine-LR single-chain antibody (scAb) variants were spotted onto epoxy-silane, amine-binding, and Ni-NTA slide surfaces.

The antibody fragments were combined with five different sets of functional groups. These functional groups are:

1.) Hexa-histidine tag,
2.) Hexa-histidine plus 4-lysine tag,
3.) Hexa-histidine plus AviTag™
4.) Hexa-histidine plus C-terminal cysteine tag

In the case of epoxy silane slides, Histidine-tag and amino-modified, Cy3-labelled oligonucleotides were applied as positive spotting controls. PBS and water was spotted as negative spotting control. The AviTag™ modified scAbs was biotinylated prior to spotting by applying biotin-protein ligase birA. The amount of bound scAbs was determined using the Deep Purple™ total protein staining method.

As can be seen in FIG. 6 the anti-atrazine 4D8 antibody fragments could be successfully bound to epoxy silane glass slides. The spot to spot variation and also the variation between the two identical subarrays on one slide is quite low. Biotin, histidine-tag, and lysine-tag modified scAbs showed very similar binding pattern. There was an increase in the amount of bound protein, represented by the fluorescence intensity values, from 0.1 mg/mL to 0.5 mg/mL spotted protein. An increase in the antibody concentration to 1 mg/mL yielded no further increase in the fluorescence signal. The observation that these three antibody variants react quite similarly indicates that the major impact on the binding towards the epoxy groups is caused by the histidine tag which all of these three antibody variants have at their C-terminus.

### Example 2

### Further Experiments

A key aim of this invention is to optimise assay performance by improving immobilisation procedures. As will be demonstrated below, it was found that histidine-tag modified oligonucleotides displayed a significantly enhanced performance over other investigated DNA modifications.

To carry out this investigation, and in order to demonstrate the interaction with the epoxy silane surface, a set of five different peptide-oligonucleotide conjugates was tested, consisting of aromatic and aliphatic peptides with and without terminal amino groups bound to a 40-mer HCV viral load probe from Eurogentec (Seraing, Belgium).

TABLE 1
Peptide-tag oligonucleotide conjugates obtained
from Eurogentec:

| Oligo | | Abbre- |
|---|---|---|
| # | Conjugate description | viations |
| 1 | oligo-His-His-His-His-His-His-NH₂ | His |
| 2 | oligo-His-His-His-His-His-His- | AcHis |
| | NH—C(O)—CH₃ | |
| 3 | oligo-Tyr-Tyr-Tyr-Tyr-Tyr-Tyr-NH₂ | Tyr |
| 4 | oligo-Lys-Lys-Lys-Lys-Lys-Lys-NH₂ | Lys |
| 5 | oligo-Ala-Leu-Ala-Leu-Ala-Ala-NH₂ | Ala |

| | |
|---|---|
| Oligo | 5′- T CGC AAG CAC CCT ATC AGG CAG TAC CAC |
| | AAG GCC TTT CGC -3′ |

The impact of the different oligonucleotide modifications on the assay sensitivity was analysed in a viral load benchmark type experiment with concentrations of Cy3-labelled 40-mer targets between 1 fM and 1 nM and a negative control mock hybridization only with the hybridization buffer.

### Materials and Methods

### DNA Array Preparation:

Differentially modified oligonucleotides (0.2 μM, 2 μM, and 20 μM) were spotted in 1× Schott Nexterion spot buffer on Schott Nexterion Slides E (epoxy silane modified surface) with a Microgrid II spotter using 200 μm solid pins. Thiol-modified oligonucleotides were spotted in 1× Schott Nexterion spot buffer containing 5 mM Tris(2-carboxy-ethyl)phosphine hydrochloride (TCEP) to cleave the mercapto-ethyl protection group. TCEP containing spotting solutions were incubated for 30 min at RT before printing. The oligonucleotide probe molecules were immobilized by incubating the slides in a humidity chamber for 1 h followed by storage over night at room temperature (RT) under dry conditions.

The slides were then washed with 0.1% TritonX-100 solution under constant mixing for 5 min at RT, with 1 mM HCl solution for 4 min, with 100 mM KCl solution for 10 min, and with deionized water for 1 min. The slides were blocked with 50 mM ethanolamine+0.1% sodium dodecyl sulfate (SDS) in 0.1 M Tris buffer (pH 9) for 15 min at 50° C. After blocking the slides were washed in deionized water for 1 min and then dried by centrifugation (2 min at 1000 rpm).

### Hybridization

Arrays were hybridized with 50 μL Cy3-labelled 40-mer target solution in 4×SSC buffer+0.01% SDS with an Agilent 8 well gasket slide in an Agilent hybridization oven at 55° C. under agitation (rotation speed 4). After hybridization the arrays were washed with 2×SSC+0.2% SDS solution for 10 min at RT under constant mixing, with 2×SSC solution for 10 min at RT, and with 0.2×SSC for 10 min. After dipping into water the slides were dried by centrifugation (2 min at 1000 rpm).

Target sequence

5′-GCG AAA GGC CTT GTG GTA CTG CCT GAT AGG GTG CTT
GCG A [5′] = Cy3

### Fluorescence Scanning

Fluorescence images were generated with a Tecan LS Relaoded fluorescence scanner with excitation at 532 nm and emission at 575 nm at PMT 200.

### Detection Limit

The detection limit was determined by the mean of the fluorescence intensity of the negative control thiol-modified HCMV probe (20 μM) plus two times the standard deviation.

### Results

DNA microarrays containing oligonucleotide probes with the five different peptide tags as well as amino- and thiol-modifications at three different concentrations were produced on epoxy silane slides. FIG. 7 and FIG. 8 show the fluorescence intensities obtained after hybridization with 100 μM and 10 μM Cy3-labelled 40-mer target, respectively. Besides the HCV specific probes HCMV negative control probes were added to the array. FIG. 7 and FIG. 8 show that tyrosine and histidine-tagged probes yielded substantially higher fluorescence intensities than amino- or thiol-modified probes. The fluorescence intensity obtained with alanine/leucine-tagged probes lay in the range of thiol-modified probes. Histidine-tagged probes without free terminal amino-groups (AcHis) yielded about half the fluorescence intensity, which was obtained with histidine-tagged probes with free terminal amino-groups. This is an indication for a significant impact of the terminal amino-group on the binding to the epoxy silane functional groups on the surface of the slides. Whereas the difference sensitivity obtained with the peptide-tagged probes compared to amino-modified probes show that the peptides have an additional effect favouring the hybridization event.

The comparison of the detection limits obtained with the different probe modifications showed a significant impact of the modification on the assay sensitivity (see Table 2). The lowest detection limit of 10 fM was obtained with histidine-tagged probes with free terminal amino-groups. This means an increase in sensitivity compared to traditional probe modifications (thiol and amino) of two and three orders of magnitude, respectively.

TABLE 2
Detection limit obtained with different probe modifications:

| Modification | Detection limit [pM] |
|---|---|
| Amino | 10 |
| Thiol | 1 |
| Alanine/Leucine-Tag | 1 |
| Lysine-Tag | 0.1 |
| Tyrosine-Tag | 0.1 |
| Acetylated-Histidine-Tag | 1 |
| Histidine-Tag | 0.01 |

1. A method of attaching a substance to a surface, which method comprises contacting a surface comprising amine reactive groups with a substance labelled with a peptide tag such that the substance is covalently attached to the surface via the peptide tag, wherein the peptide tag comprises one or more histidine residues, one of which is a terminal histidine residue having a free N-terminal amino group.

2. A method according to claim 1, wherein the substance is attached to the surface through a secondary amine group of the terminal histidine residue.

3. (canceled)

4. A method according to claim 2 wherein a further step comprises detecting the presence or absence of the substance.

5. A method according to claim 4 wherein a further step comprises detecting the quantity of the substance.

6. A method according to claim 3 wherein a further step comprises washing the surface with a liquid.

7. A method according to claim 6 wherein the wash step occurs after attaching the substance to the surface but before the processing or analysis step.

8. A method of processing or analysis comprising the steps of:
(a) attaching a substance to a surface by a method as defined in claim 1;
(b) contacting the surface with a sample comprising an analyte in order that the analyte in the sample binds to the substance attached to the surface; and
(c) processing and/or analyzing the analyte.

9. A method according to claim 8 which further comprises a mixing step.

10. A method according to claim 8 which further comprises the step of washing the surface with a liquid.

11. A method according to claim 10 wherein the wash step occurs after step b) but before step c).

12. A method according to claim 8 wherein step c) comprises detecting the presence or absence of the analyte in the sample.

13. A method according to claim 8 wherein step c) comprises detecting the quantity of the analyte in the sample.

14. A method according to claim 8 wherein step c) comprises detecting a signal caused by an analyte in the sample binding to a substance attached to the surface.

15. A method according to claim 8 for analysing a plurality of analytes, wherein a plurality of substances are attached to the surface, each substance being specific to a different analyte.

16. A method according to claim 15 wherein different substances are attached to different areas of the surface, such that different analytes bind to different areas of the surface to enable different analytes to be processed or analysed independently of each other.

17. A method according to claim 15 which comprises measuring the relative quantities of two or more different analytes in the sample.

18. A method according to claim 15 wherein each different analyte produces a signal which can be distinguished from the signals produced by other analytes.

19. A method according to claim 18 wherein the relative intensities of each signal are used to measure the relative quantities of each different analyte.

20. A method according to claim 8 wherein either the analytes in the sample or the substances attached to the surface each further comprise a reporter group.

21. A method according to claim 20 wherein each different analyte or substance comprises a different reporter group.

22. A method according to claim 21 wherein each different reporter group produces a signal which can be distinguished from the signals produced by other reporter groups.

23. A method according to claim 20 wherein the reporter group is a fluorescent molecule.

24. A method according to claim 23 wherein the fluorescent molecule is Cy3 Cy5, Fluorescein or TAMRA.

25. A method according to claim 20 wherein the reporter group is a nanoparticle, a quantum dot or an electrochemical label.

26. A method according to claim 18 wherein a signal is detected by fluorescence spectroscopy.

27. A method according to claim 18 wherein the signal is detected by one or methods selected from optical waveguide detection, dual polarisation interferometry, surface plasmon resonance, UV or visible spectroscopy, Fourier transform infrared spectroscopy (FTIR), Raman spectroscopy, ELISA, mass spectrometry, electrochemical, mechanical detection, gravimetric, microbalance, piezoelectric or surface acoustic wave (SAW) detection.

28. A method according to claim 1 wherein the substance and/or analyte is selected from proteins, peptides, polypeptides, carbohydrates, nucleic acids, locked nucleic acids, peptide nucleic acids or oligonucleotides.

29. A method according to claim 28 wherein the substances are oligonucleotides and wherein each analyte in the sample is an oligonucleotide and comprises a nucleotide sequence which is complementary to a nucleotide sequence of one or more of the substances attached to the surface.

30. A method according to claim 29 wherein hybridization of the complementary sequences occurs in step b).

31. A method according to claim 1 wherein the surface is the surface of a microarray.

32. A product for analyzing one or more analytes in a sample comprising:
a surface comprising amine-reactive groups; and
a substance covalently bound to the surface via a peptide tag comprising one or more histidine residues, one of which is an N-terminal histidine residue, whereby the substance bound to the surface is capable of binding to an analyte of interest.

33. A product according to claim 32, wherein the substance is attached to the surface through a secondary amine group of the terminal histidine residue.

34. A product according to claim 32, wherein different analytes are attached to different areas on the surface.

35. A product according to claim 34 which is a microarray.

36. A kit for analyzing one or more analytes in a sample comprising:
a substrate which has a surface comprising amine-reactive groups; and
a liquid comprising one or more substances capable of binding to an analyte of interest in the sample; each substance labelled with a peptide tag comprising one or more histidine residues, one of which is a terminal histidine residue having a free N-terminal amino group.

37. A kit according to claim 36, wherein the substance is capable of attaching to the surface through a secondary amine group of the terminal histidine residue.

38. A product or kit according to any of claims 32 or 36 wherein the analytes and/or substances are selected from proteins, peptides, polypeptides, carbohydrates, nucleic acids, locked nucleic acids, peptide nucleic acids or oligonucleotides.

39. A method, product or kit according to claim 1, 32 or 36, wherein the surface comprises N-hydroxysuccinimide ester groups.

40. A method, product or kit according to claim 1, 32 or 36, wherein the surface comprises epoxy-silane or CodeLink™.

41. A method, product or kit according to claim 1, 32 or 36, wherein the peptide tag comprises 1 to 12 histidine residues, 1 to 8 histidine residues, or 6 histidine residues.

42-43. (canceled)

44. A method, product or kit according to claim 1, 32 or 36, wherein the peptide tag comprises one or more cysteine residues, and/or one or more tyrosine residues, and/or one or more lysine residues.

45. A method, product or kit according to claim 1, 32 or 36, wherein the surface is situated on a substrate.

46. A method, product or kit according to claim 45 wherein the substrate comprises glass, metal, metal oxide, silicon dioxide, silicon nitride, ceramic, semiconductor, polymer or plastic.

47. A method of using a peptide comprising six histidine residues and optionally one or more cysteine residues, wherein the terminal histidine residue has a free N-terminal amino group for covalently attaching an oligonucleotide to a surface.

48. The method according to claim 47, wherein the oligonucleotide is attached to the surface through a secondary amine group of the terminal histidine residue.

49. The method according to claim 47, wherein the surface comprises epoxy-silane, or CodeLink™.


SEQUENCE LISTING (6 sequences)

SEQ ID NO: 1 - protein, 6 aa, Artificial Sequence
  poly-His tag
HHHHHH

SEQ ID NO: 2 - protein, 6 aa, Artificial Sequence
  Poly Tyr tag
YYYYYY

SEQ ID NO: 3 - protein, 6 aa, Artificial Sequence
  Poly Lys tag
KKKKKK

SEQ ID NO: 4 - protein, 6 aa, Artificial Sequence
  Peptide tag
AALALA

SEQ ID NO: 5 - DNA, 40 bp, Artificial Sequence
  Oligonucleotide domain
tcgcaagcaccctatcaggcagtaccacaaggcctttcgc

SEQ ID NO: 6 - DNA, 40 bp, Artificial Sequence
  Oligonucleotide target sequence
gcgaaaggccttgtggtactgcctgatagggtgcttgcga